(19) United States
(12) Patent Application Publication
(10) Pub. No.: US 2010/0119016 A1
(43) Pub. Date: May 13, 2010

(54) FFT-BASED PILOT SENSING FOR INCUMBENT SIGNALS

(75) Inventor: Monisha Ghosh, Chappaqua, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/529,420

(22) PCT Filed: Mar. 19, 2008
(86) PCT No.: PCT/IB08/51041

§ 371 Date: Sep. 1, 2009

Related U.S. Application Data
(60) Provisional application No. 60/895,568, filed on Mar. 19, 2007.

(51) Int. Cl. H04L 27/06

(52) U.S. Cl. 375/340

(57) ABSTRACT

The presence of an incumbent signal is detected in order to allow secondary users to share spectrum white space with incumbent users who have pre-emptive access to the spectrum. The spectrum is relinquished to the incumbent user to preclude any potential harmful interference and enable spectrum sharing. The presence of an incumbent signal (39) is detected by performing a frequency domain transformation on a received signal (51) to generate a plurality of frequency-domain components (53). A maximum frequency domain component is identified from among the plurality of frequency-domain components (53). The identified maximum frequency domain component is squared, and the result is compared to a detection threshold value to determine if the incumbent signal is present.

This application claims the benefit of the U.S. provisional application Ser. No. 60/895,568, filed on Mar. 19, 2007.

The present invention relates to communication systems that include cognitive radios and/or software defined radios (SDRs) to achieve efficient and reliable spectrum use without harmful interference to incumbent services such as television (TV) receivers.

A number of proposals have been made to allow the use of TV spectrum by unlicensed devices, provided that the unlicensed users do not create harmful interference to the incumbent users of the spectrum. It is envisioned that these unlicensed devices will possess the capability to autonomously identify channels within licensed television bands where they may transmit without creating harmful interference.

An Institute of Electrical and Electronics Engineers (IEEE) 802.22 Wireless Regional Area Network (WRAN) Working Group is preparing a standard with respect to a physical (PHY) and Media Access Control (MAC) layer interface. The interface enables a non-allowed system to utilize a spectrum, which is assigned to a television (TV) broadcasting service, based on cognitive radio (CR) technology. To coexist with an incumbent system and avoid an interference, which may affect existing services such as a TV broadcast, a wireless microphone, and the like, a MAC protocol of IEEE 802.22 enables a CR base station to dynamically change a channel currently in use, or a power of a CR terminal when a usage of a spectrum, used by the incumbent system, is detected.

Pilot detectors have been proposed to determine the presence of an active television channel. However, there are a number of problems associated with the detection and identification of licensed Digital Television (DTV) transmissions for the purpose of determining whether or not an unlicensed device can share a particular television channel. Most pilot energy detection methods filter the region around the pilot and then measure the energy in the narrowband signal. If the signal energy is above a certain threshold, the signal is declared detected. The method is very sensitive to the threshold, and any uncertainty in the noise level can degrade performance. Moreover, if the pilot is in a deep fade, which can be quite common, the probability of detection can be quite low. A further problem with pilot energy detection methods is the uncertainty in the pilot location, which could require a 100 KHz bandwidth filter. However, the larger the filter, the more degraded the performance.

In accordance with various embodiments of the present invention, FFT-based pilot detection quickly and robustly detects the presence of an incumbent signal and rapidly relinquishes the spectrum to an incumbent user to preclude any potential harmful interference and enable efficient and reliable spectrum sharing.

It is understood that incumbent users are endowed with pre-emptive access to the spectrum, whereas secondary users (e.g., cognitive radio users and software radio users) only have access rights for opportunistic usage in the spectrum white spaces on a non-interfering basis with the incumbent users. White spaces are well-known in the communication arts and defined as allocated but virtually unused portions of a wireless spectrum.

In accordance with one embodiment of the present invention, an FFT-based pilot detection is based on the energy of a pilot in a detected carrier signal. A received signal is demodulated to baseband using the known nominal pilot position. The baseband signal is filtered with a low-pass filter large enough to accommodate any unknown frequency offsets. The filtered signal is down-sampled, taking the FFT of the sub-sampled signal, where the FFT size depends on the dwell-time of the sensing window. Pilot energy detection is performed by finding the maximum of the FFT output-squared in a single dwell window and comparing it to a pre-determined threshold.

In accordance with a further embodiment of the present invention, an FFT-based pilot detection is based on a location of a pilot in a detected carrier signal. A received signal is demodulated to baseband using the known nominal pilot position. The baseband signal is filtered with a low-pass filter large enough to accommodate any unknown frequency offsets. The filtered signal is down-sampled, taking the FFT of the sub-sampled signal, where the FFT size depends on the dwell-time of the sensing window. Pilot location detection is performed by finding a location of the maximum of the FFT output-squared and comparing it between multiple dwells.

Various embodiments of the present invention are illustrated in the figures of the accompanying drawings which are meant to be exemplary and not limiting, in which like reference characters are intended to refer to like or corresponding parts, and in which:

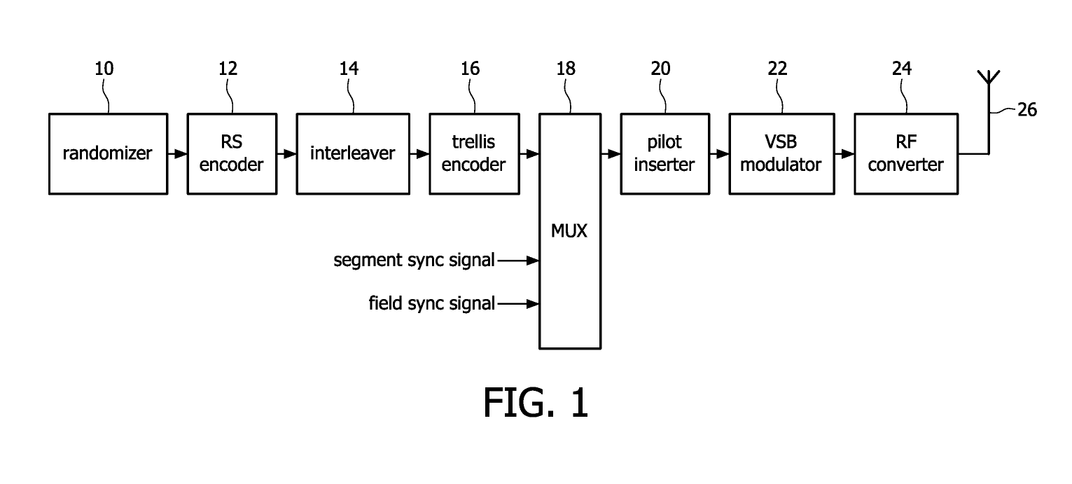

FIG. 1 illustrates a block diagram of a conventional ATSC 8-VSB transmitter;

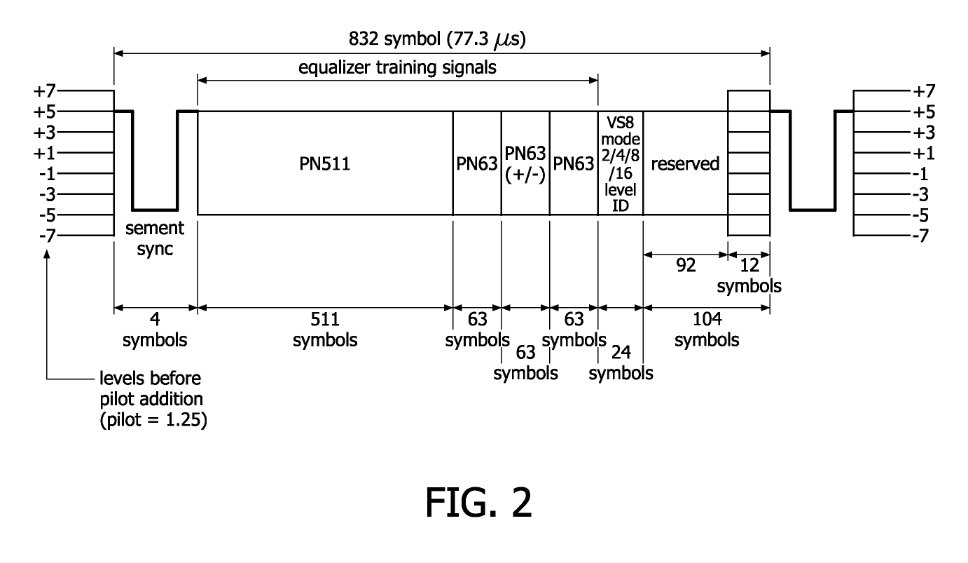

FIG. 2 is a diagram illustrating the structure of a field synchronization signal of the VSB signal of FIG. 1;

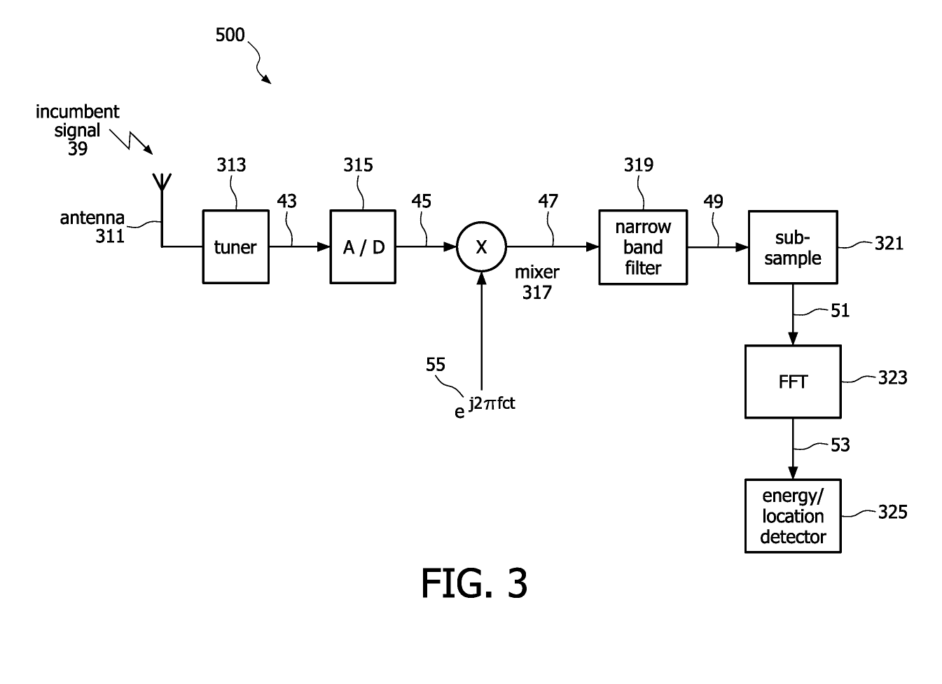

FIG. 3 illustrates a block diagram showing a detector in accordance with an embodiment of the present invention;

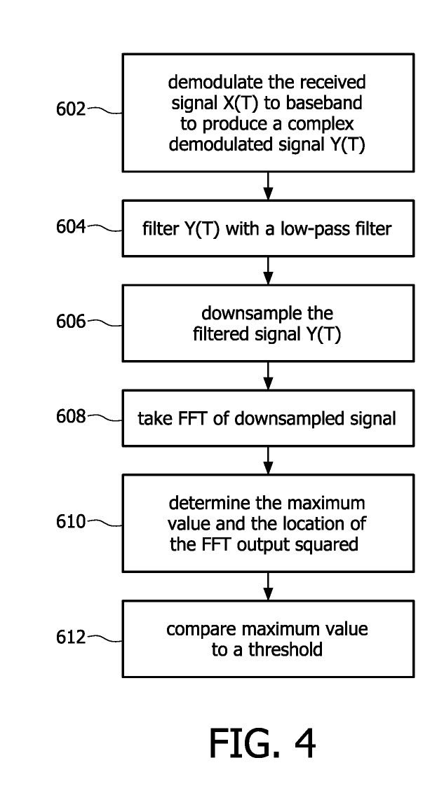

FIG. 4 is a flowchart illustrating a method for detecting the presence of an incumbent signal with a low signal-to-noise ratio by performing an FFT-based pilot detection based on the energy of a pilot in the incumbent signal.

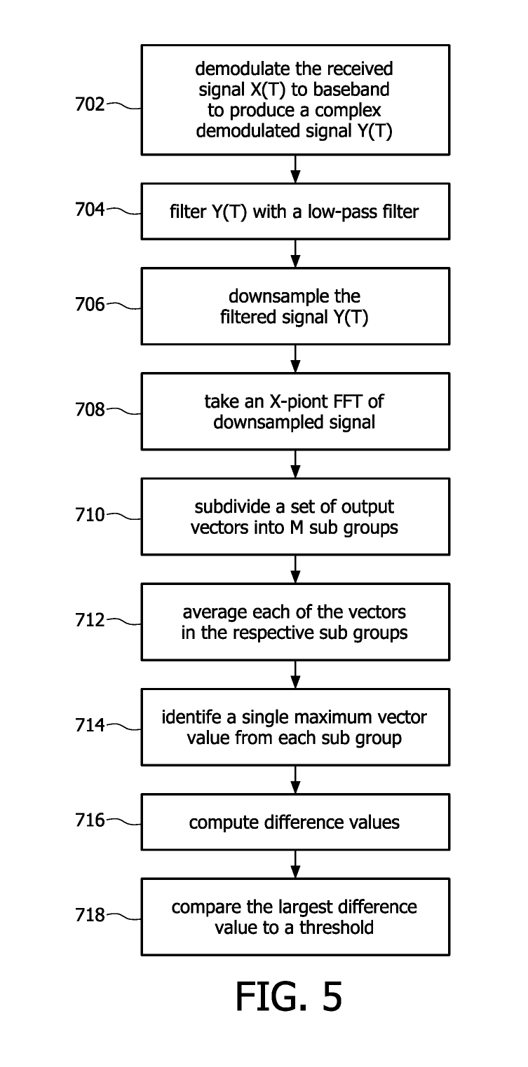

FIG. 5 is a flowchart illustrating another embodiment of the present invention for detecting the presence of an incumbent signal with a low signal-to-noise ratio by performing an FFT-based pilot detection by observing the location of the maximum FFT value over successive intervals;

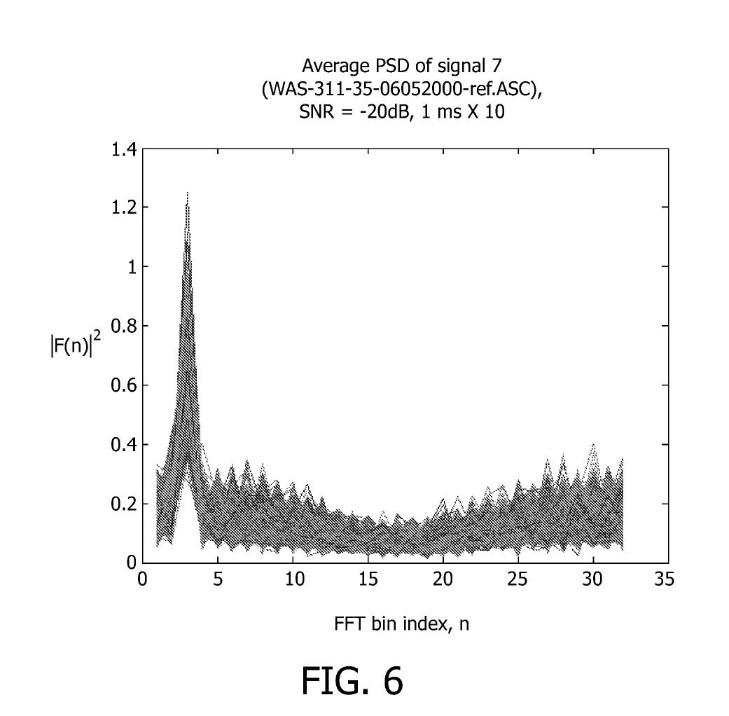

FIG. 6 illustrates a simulation result for a 32-point FFT in detecting a signal x(t) with a strong pilot for ten dwells, i.e., N=10, where the detection is based on the energy of a pilot in a detected signal x(t);

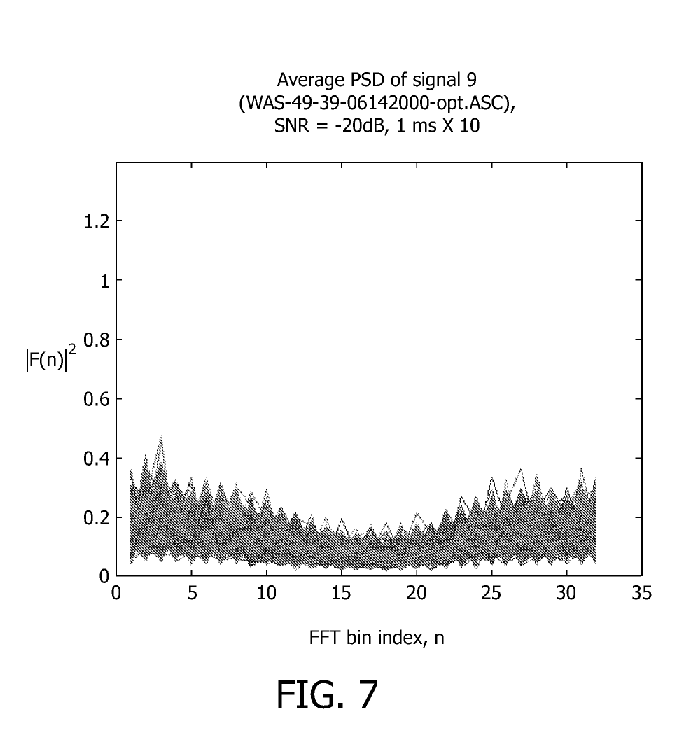

FIG. 7 illustrates a simulation result for a 32-point FFT in detecting a signal x(t) with a weak pilot for ten dwells, i.e., N=10, where the detection is based on the energy of a pilot in a detected signal x(t); and

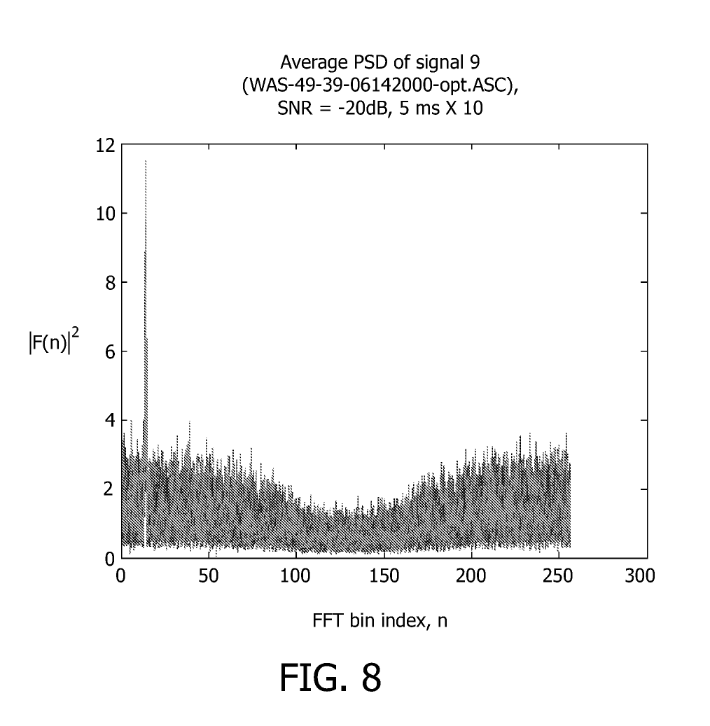

FIG. 8 illustrates a simulation result for a 256-point FFT in detecting a signal x(t) with a weak pilot for ten dwells, i.e., N=10, where the detection is based on the energy of a pilot in a detected signal x(t).

The present invention is now described in more detail in terms of an exemplary system, method and apparatus for providing a robust and efficient solution for quickly and robustly detecting the presence of an incumbent signal, especially with a low signal-to-noise ratio, by performing an FFT-based pilot detection. Spectrum sensing is the key enabler for dynamic spectrum access as it can allow secondary networks to reuse spectrum without causing harmful interference to primary users. Accordingly, the invention can be characterized in one way as a spectrum sensing technique based on FFT-based pilot detection.

The present invention is applicable for use with one or multiple sensing dwells (windows), which fits well with the MAC sensing architecture by allowing the QoS of secondary services to be preserved despite the regularly scheduled sensing windows.

The spectrum sensing described herein is particularly, but not exclusively, designed for operation in highly dynamic and dense networks and have been adopted in the current draft of the IEEE 802.22 standard. The spectrum sensing described herein is designed to primarily protect two types of incumbents, namely, the TV service and wireless microphones. In particular, wireless microphones are licensed secondary users of the spectrum, and are allowed by the FCC to operate on vacant TV channels on a non-interfering basis.

FIG. 1 illustrates a block diagram of a conventional digital broadcasting transmission apparatus, which is used for regularly inserting and transmitting known data. It is a standard 8-level vestigial sideband (VSB) transmission apparatus and includes a randomizer 10, a Reed-Solomon (RS) encoder 12, an interleaver 14, a trellis encoder 16, a multiplexer (MUX) 18, a pilot inserter 20, a VSB modulator 22, and a radio frequency (RF) transformer 24.

The pilot inserter 20 inserts pilot signals into the symbol stream from the multiplexer 18. The pilot signal is inserted after the randomization and error coding stages so as not to destroy the fixed time and amplitude relationships that these signals possess to be effective. Before the data is modulated, a small DC shift is applied to the 8-VSB baseband signal. This causes a small residual carrier to appear at the zero frequency point of the resulting modulated spectrum. This is the pilot signal provided by the pilot inserter 20. This gives RF phase-lock-loop (PLL) circuits in a VSB receiver something to lock onto that is independent of the data being transmitted. After the pilot signal is inserted by the pilot inserter 20, the output is subjected to a VSB modulator 22. The VSB modulator 22 modulates the symbol stream into an 8 VSB signal of an intermediate frequency band. The VSB modulator 22 provides a filtered (root-raised cosine) IF signal at a standard frequency (44 MHz in the U.S.), with most of one sideband removed.

In particular, the eight level baseband signal is amplitude modulated onto an intermediate frequency (IF) carrier. The modulation produces a double sideband IF spectrum about the carrier frequency. However, the total spectrum is too wide to be transmitted in the assigned 6 MHz channel. The sidelobes produced by the modulation are simply scaled copies of the center spectrum, and the entire lower sideband is a mirror image of the upper sideband. Therefore using a filter, the VSB modulator discards the entire lower sideband and all of the sidelobes in the upper sideband. The remaining signal—upper half of the center spectrum—is further eliminated in one-half by using the Nyquist filter. The Nyquist filter is based on the Nyquist Theory, which summarizes that only a ½ frequency bandwidth is required to transmit a digital signal at a given sampling rate.

Further according to FIG. 1, RF (Radio Frequency) converter 24 converts the signal of an intermediate frequency band from the VSB modulator 22 into a signal of a RF band signal, and transmits the signal to a reception system through an antenna 26.

Each data frame of the 8-VSB signal has two fields, i.e., an odd field and an even field. Each of the two fields has 313 segments, with a first segment corresponding to a field synchronization (sync) signal. FIG. 2 is a diagram illustrating the structure of a field synchronization signal of the 8-VSB signal of FIG. 1. As illustrated in FIG. 2, each of the segments of the odd and even fields has 832 symbols. The first four symbols of each of the segments in each of the odd and even fields contain a segment synchronization signal (4-symbol data-segment-synchronization (DSS)) sequence.

In order to make the VSB signal more receivable, training sequences are embedded into the first segment (containing the field sync signal) of each of the odd and even fields of the VSB signal. The field synchronization signal includes four pseudo-random training sequences for a channel equalizer: a pseudo-random number (PN) 511 sequence, comprised of 511 symbols; and three PN63 sequences, each of which is comprised of 63 symbols. The sign of the second PN63 sequence of the three PN63 sequences changes whenever a field changes, thereby indicating whether a field is the first (odd) or second (even) field of the data frame. A synchronization signal detection circuit determines the profile of the amplitudes and positions (phase) of received multi-path signals, using the PN511 sequence, and generates a plurality of synchronization signals necessary for various DTV reception operations, such as a decoding operation.

Referring to FIG. 3, an exemplary embodiment of a detector 500 is shown. It should be understood that the parameters of the detector 500 can be chosen depending on the desired sensing time, complexity, probability of missed detection and probability of false alarm. According to FIG. 3, the detector 500 includes an antenna, 311, a tuner 313, an A/D converter 315, a complex mixer 317, a narrow band filter 319, a sub-sample unit 321, an FFT unit 323, and an energy/location detector 325.

The tuner 313 is used for receiving an incumbent signal 39 and providing a low IF (LIF) signal 43. The analog-to-digital (A/D) converter 315 is used for sampling the low IF (LIF) signal 43 at a sample rate at least twice the highest frequency and converting the low IF (LIF) signal 43 into a digital LIF signal 45. The digital LIF signal 45 is supplied as a first input to the complex mixer 317, where it is combined with a reference signal 55, output from an oscillator (not shown) having a characteristic frequency f_{c} equal to the carrier frequency. The complex mixer 317 outputs a complex demodulated baseband signal 47. Complex demodulated baseband signal 47 is provided as input to narrow band filter 319 which is used for performing a low-pass filtering and producing a filtered complex demodulated baseband signal 49. A sub-sample unit 321 down-samples the filtered complex demodulated baseband signal 49 and outputs a down-sampled filtered complex demodulated baseband signal 51. The FFT unit 323 receives the down-sampled filtered complex demodulated baseband signal 51, generates an FFT window and performs an FFT processing on the down-sampled filtered complex demodulated baseband signal 51. The FFT unit 323 outputs a plurality of frequency-domain component signals 53. The energy/location detector 325 receives the plurality of frequency-domain component signals 53 and outputs a single determination regarding the presence or absence of the incumbent signal 39.

In each of the embodiments described herein the choice of a threshold is determined by the desired probability of false alarm, P_{FA}.

FIG. 4 is a flowchart illustrating another embodiment of the present invention for detecting the presence of an incumbent signal with a low signal-to-noise ratio by performing an FFT-based pilot detection based on the energy of a pilot in the incumbent signal. As an example, the carrier signal x(t) to be detected is assumed to be a band-pass signal at a low-IF, 5.38 MHz, with a nominal pilot location of 2.69 MHz. It is further assumed that the signal is sampled at 21.52 MHz.

It is understood, however, that the acts described with reference to FIG. 4 can be implemented with suitable modifications to detect any signal including a pilot, with the signal being transmitted at any IF or RF frequency and sampled at any suitable sampling rate. At block 602, a received signal is demodulated to baseband using a nominal frequency offset of f_{c}=2.69 MHz. The nominal frequency offset is applied to place the pilot signal close to DC.
x(t)=the real bandpass signal at low-IF (e.g., 5.38 MHz)
y(t)=x(t)e^{-j2πfct}=a complex demodulated signal at baseband

At block 604, the complex demodulated baseband signal y(t) is filtered with a low-pass filter of bandwidth. Generally, the filter bandwidth is large enough to accommodate any unknown frequency offsets in the signal. In some embodiments, pilot-energy detection can be made more robust by narrowing a filter bandwidth without compromising the detectability of signals with large frequency offsets. At block 606, the filtered signal y(t) is down-sampled from 21.52 MHz to 53.8 KHz. At block 608, the FFT of the down-sampled signal is taken to generate a plurality of frequency-domain component signals. Depending on the dwell time, the length of the FFT can vary. For example, a 1 ms dwell will allow a 32-point FFT. A 5 ms dwell will allow a 512-point FFT. It is noted that increasing the dwell time improves performance. At block 610, in a single dwell, a maximum value of the FFT output squared is identified, as well as its location. At block 612, this value is compared to an energy threshold value to detect signal presence.

It is appreciated that the above acts may be performed in software or firmware by a processing unit such as a microprocessor, DSP, or the like.

In another embodiment, the inventive pilot energy detection incorporates multiple dwells to determine the presence or absence of an incumbent signal based on the location. For example, N dwells may be considered where N is a positive integer greater than 1.

FIG. 5 is a flowchart illustrating another embodiment of the present invention for detecting the presence of an incumbent signal with a low signal-to-noise ratio by performing an FFT-based pilot detection by observing the location of the maximum FFT value over successive intervals. At block 702, a received signal is demodulated to baseband using an example nominal frequency offset of f_{c}=2.69 MHz. The nominal frequency offset is applied to place the pilot signal close to DC.
x(t)=the real band pass signal at low-IF (e.g., 5.38 MHz)
y(t)=x(t)e^{-j2πfct}=a complex demodulated signal at baseband

At block 704, the complex demodulated baseband signal y(t) is filtered with a low-pass filter. Generally, the filter bandwidth should be large enough to accommodate any unknown frequency offsets in the signal. At block 706, the filtered signal y(t) is down-sampled from an example 21.52 MHz to 53.8 KHz. At block 708, an x-point FFT of the down-sampled signal is independently performed in N consecutive dwells, from which N independent 512×1 vectors are respectively output, V₁ through V_{N}. The size of the x-point FFT is preferably a power of 2. For example, a {32×1}, {64×1}, {128×1} or {512×1} FFT.

$${V}_{1} = [ ( {FFT}_{out - 1} ) , ( {FFT}_{out - 2} ) , … ( {FFT}_{out - 512} ) ]$$

$$⋮$$

$${V}_{N} = [ ( {FFT}_{out - 1} ) , ( {FFT}_{out - 2} ) , … ( {FFT}_{out - 512} ) ]$$

It is understood that there is no restriction or limitation on the number of dwells that may be used. In other words, the number of dwells, N, can be a positive integer equal to or greater than 1. The length of the FFT used is related to the dwell time in each dwell. For example, a 1 ms dwell allows a 32-point FFT, where a 5 ms dwell allows a 512-point FFT.

At block 710, the set of vectors V₁ through V_{N} are divided into a number of groups M. In one embodiment of the present invention, the set of vectors V₁ through V_{N} are divided into two groups, such that M=2. Preferably, each group contains an identical number of vectors. For example, in the case of two groups (M=2), each group has N/2 vectors. Namely, the first group is comprised of vectors {V₁ through V_{N/2}}, and the second group is comprised of {V_{N/2} through V_{N}}.

It is understood that there is no restriction or limitation on the number of groups M that may be created from the initial vector set N. For example, in one embodiment, it is contemplated to divide the vector set N comprised of vectors V₁ through V_{N} into four groups (M=4), with each group being comprised of N/4 vectors. Similarly, in another embodiment, it is contemplated to divide the vector set N comprised of vectors V₁ through V_{N} into eight groups (M=8), with each group being comprised of N/8 vectors.

At block 712, each of the vectors in the respective group is averaged. For example, where N=10, M=2 and FFT=512, the 5 vectors in each of the respective two groups are averaged. At block 714, a single maximum vector value fₘₐₓ is identified in each of the vector groups. At block 716, a difference value D is computed as the difference between the maximum vector values f_{max-group-1} and f_{max-group2}, in the case where N=10 and M=2. In a case where there are multiple groups, a difference value is computed between each group. For example, in the case of 4 groups, 8 difference values are computed. At block 718, the largest (or the only) difference value Dₘₐₓ is compared with a threshold value to determine the presence of absence of an incumbent signal.

FIG. 6 illustrates a simulation result that was obtained for a 32-point FFT in detecting a signal x(t) including a strong pilot, for a single dwell, i.e., N=1, where the detection was based on the energy of a pilot in a detected signal x(t). FIG. 7 illustrates the drawback of using a 32-point FFT in trying to detect a weak pilot signal. In this case, a higher order FFT is preferable to extract the weak pilot signal. FIG. 8 illustrates a better performance result with improved resolution when using a higher order FFT. As shown in FIG. 10, the 256-point FFT easily detects the faded pilot signal which was not achievable using the 32-point FFT of FIG. 7.

It will be appreciated that another algorithm can be substituted for the FFT. It will also be appreciated that there is no restriction or limitation on the length of the averaging interval. For example, a single long dwell of 10 ms may be used together with a 512-point FFT (or another algorithm) to obtain better detection performance.

Like the digital ATSC standard, the analog National Television System Committee (NTSC) broadcast signals also contain a pilot signal and other known synchronization signal components that can be used for the receiver's position location. The present invention applies to the analog NTSC broadcast signals. For example the horizontal scan synchronization signal occurs in each horizontal scan time of 63.6 microseconds. This 63.6 microsecond is equivalent to the segment time interval discussed earlier while this horizontal scan synchronization signal plays a similar role to the segment synchronization bit waveform of the digital ATSC standard. For these analog TV broadcast signals there is also a known Ghost Canceling Reference (GCR) signal that occurs periodically, which is used by the TV receivers to combat multipath during signal propagation from the transmitter to the receivers. This GCR signal is analogous to the Field Synchronization Segment signal of the digital ATSC broadcast signal. The present invention also extends to other types of analog TV broadcast signals.

The European Telecommunications Standards Institute (ETSI) established the Digital Video Broadcasting-Terrestrial (DVB-T) standard, which is based on the use of Orthogonal Frequency Division Multiplexing (OFDM) signals. The present invention is applicable to DVB-T and the closely related Japanese Integrated Services Digital Broadcasting-Terrestrial (ISDB-T) system. The 8K mode of the DVB-T system, for example, consists of 6,816 OFDM carriers where each carrier is QAM modulated (QPSK is a special case) with a coded data symbol of 896 microsecond duration. The entire set of 6,816 data symbols is referred to as one symbol of this DVB-T broadcast signal. The individual QAM modulated symbols with carriers of 896 microsecond duration are sometimes called cells. Many of these cells are fixed and used for the purpose of synchronization at the TV receivers. These known synchronization cells, called pilot carriers or cells, can be used to determine the receiver's position location based on the present invention.

The present invention is applicable to other OFDM broadcast signals, such as the ETSI Digital Audio Broadcast (DAB) and the United States In-Band On-Channel (IBOC) digital audio broadcast systems. OFDM audio broadcast signals are also used by the terrestrial relays of the Satellite Digital Audio Radio Service (SDARS) systems of Sirius and XMRadio.

In the embodiments described herein, to quickly and robustly detect the presence of an incumbent user, an FFT-based pilot detection method is used in a cognitive radio or software radio device of a secondary user that leverages on a known position of a pilot in the incumbent signal to detect its presence. In this manner, the invention has general applicability to any incumbent signal which incorporates at least one pilot signal. Further, the invention is especially, but not exclusively, suited to carrier signals having a low signal-to-noise ratio.

In accordance with different embodiments of the invention, the FFT-based pilot detection of the invention may be based on different criteria including, without limitation, the location of a pilot in a detected signal or on the energy of the pilot in the detected signal. In other embodiments, various combining schemes are contemplated which combine these criteria to pilot detection, for example location and energy.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method for detecting the presence of an incumbent signal (39), comprising:
performing a frequency domain transformation on a received signal (51) to generate a plurality of frequency-domain components (53);
identifying a maximum frequency domain component from among the plurality of frequency-domain components (53);
squaring the identified maximum frequency domain component; and
comparing the squared maximum frequency domain component to a detection threshold value to determine if the incumbent signal is present.

2. The method according to claim 1, wherein the frequency domain transformation is an x-point FFT transformation.

3. The method according to claim 2, wherein the x-point FFT transformation is performed in a single dwell.

4. The method according to claim 2, wherein the x-point FFT transformation is performed in a plurality of dwells.

5. The method according to claim 1, wherein the frequency transformation is a power spectral density transformation.

6. The method according to claim 1, further comprising low-pass filtering the received signal in a region around said pilot in a known location of the incumbent signal (39).

7. A method for detecting the presence of an incumbent signal (39), comprising:
demodulating an incumbent signal (39) to generate a complex demodulated baseband signal (47);
low-pass filtering the complex demodulated baseband signal (47) to generate a filtered complex demodulated baseband signal (49);
down-sampling the filtered complex demodulated baseband signal (49) to produce a down-sampled filtered complex demodulated baseband signal (51);
performing a frequency domain transformation on the down-sampled filtered complex demodulated baseband signal (51) to identify a largest difference value of averaged independent vectors output from said frequency domain transformation; and
comparing the largest difference value to a threshold value to determine if the incumbent signal is present.

8. The method according to claim 7, further comprising performing an FFT operation on the down-sampled filtered complex demodulated baseband signal in N consecutive dwells; generating N independent vectors from the performed FFT operations; dividing the N independent vectors into M sub-groups; averaging the independent vectors in each of the M sub-groups, yielding a single averaged independent vector in each of said M sub-groups; computing a difference value between each of the single averaged independent vectors in each sub group; and identifying said largest difference value from among the computed difference values.

9. The method according to claim 7, wherein the frequency domain transformation is an x-point FFT transformation.

10. The method according to claim 9, wherein the x-point FFT transformation is performed in a single dwell.

11. The method according to claim 9, wherein the FFT operation is performed in a plurality of dwells.

12. The method according to claim 7, wherein the frequency domain transformation is a power spectral density transformation.

13. A system for detecting the presence of an incumbent signal, comprising:
a unit for performing a frequency domain transformation on a received signal to generate a plurality of frequency-domain components, the unit identifying a maximum frequency domain component from among the plurality of frequency-domain components, wherein the identified maximum frequency domain component is squared; and
a detector for comparing the squared maximum frequency domain component to a detection threshold value to determine if the incumbent signal is present.

14. A system for detecting the presence of an incumbent signal, comprising:
a unit for demodulating an incumbent signal to generate a complex demodulated baseband signal, the unit low-pass filtering the complex demodulated baseband signal to generate a filtered complex demodulated baseband signal and down-sampling the filtered complex demodulated baseband signal to produce a down-sampled filtered complex demodulated baseband signal;
an FFT unit for performing a frequency domain transformation on the down-sampled filtered complex demodulated baseband signal to identify a largest difference value of averaged independent vectors output from said frequency domain transformation; and
a detector for comparing the largest difference value to a threshold value to determine if the incumbent signal is present.
